(19) United States
(12) Patent Application Publication
(10) Pub. No.: US 2026/0031553 A1
(43) Pub. Date: Jan. 29, 2026

(54) PMJ WITH DIFFERENT DIAMETERS AND RUBBER UNIT WITH DIFFERENT DIAMETERS FOR CONNECTION OF ULTRA-HIGH VOLTAGE CABLE WITH DIFFERENT DIAMETERS

(71) Applicant: TAI HAN ELECTRIC WIRE CO., LTD., Gyeonggi-do (KR)

(72) Inventors: Du Hyoun HAN, Gyeonggi-do (KR); Tae Ho LEE, Chungcheongnam-do (KR); Man-Ok CHOI, Chungcheongnam-do (KR); Jeongki PARK, Seoul (KR)

(73) Assignee: TAI HAN ELECTRIC WIRE CO., LTD., Gyeonggi-do (KR)

(21) Appl. No.: 18/847,162

(22) PCT Filed: Jan. 25, 2023
(86) PCT No.: PCT/KR2023/001089

§ 371 Date: Apr. 1, 2025

(30) Foreign Application Priority Data
Mar. 15, 2022 (KR) 10-2022-0032368

(51) Int. Cl. H01R 11/07; H02G 15/184

(52) U.S. Cl. CPC H01R 11/07; H02G 15/184

(57) ABSTRACT

The present invention relates to a PMJ with different diameters for intermediate connection between ultra-high voltage cables with different diameters. The PMJ with different diameters for intermediate connection between ultra-high voltage cables with different diameters, according to the present invention, is an intermediate connection PMJ having a pair of connected power cables with different diameters, comprising: a first cable in which a first conductor, a first insulator and a first semiconductor are sequentially formed; a second cable in which the first conductor, a second conductor having a diameter greater than that of each of the first insulator and the first semiconductor, a second insulator, and a second semiconductor are sequentially formed; and a rubber unit of which the inner circumferential surface of one side has a first inner diameter connected over the first insulator and the first semiconductor of the first cable, the inner circumferential surface of the other side has a second inner diameter connected over the second insulator and the second semiconductor of the second cable, the second inner diameter being greater than the first inner diameter and including a central electrode inside the center thereof, and the inner surface of the central electrode has a shape of slanting from one side toward the other side thereof.

### TECHNICAL FIELD

The present invention relates to a pre-molded joint (PMJ) with different diameters for intermediate connection between ultra-high voltage cables with different diameters.

### BACKGROUND ART

In general, a power cable is defined as a device that transmits power by using a conductor therein.

In recent years, as a demand for electricity sharply increases, a capacity of the power cable, i.e., an amount of power supplied through the power cable, is required to be increased.

However, since the capacity of the power cable is proportional to a voltage and a current, increase in voltage requires expanding in all sorts of equipment associated with the power cable, which causes extremely high costs due to additional safety equipment.

Thus, it is advantageous to increase the current supplied through the power cable in order to increase the capacity of the power cable.

The increase in current supplied through the power cable requires increase in cross-sectional area of a conductor of the power cable, which represents increase in diameter of the conductor.

However, in a case in which a power cable with a conductor having a small diameter is already installed, an area adjacent thereto may require a power cable having a larger capacity.

The case may require replacing all cables including the previously installed power cable with a high capacity cable, which causes extremely high costs.

In order to avoid spending the extremely high costs, a high-capacity cable is installed only in required areas, and a joint area (transition area) that connects the previously installed small-capacity cable with the newly installed high-capacity cable is required.

Thus, when the power cables are connected in the joint area, cables with different diameters are connected.

In this case, a joint method such as brazing or arc welding is mainly used.

An example related to this is disclosed in Korean Patent Publication No. 10-2017-0120936.

However, this typical technology has a problem in that additional material costs are required to connect conductors with different diameters, and labor involved in conductor connecting work is increased due to an additional welding process.

Also, all the brazing or arc welding processes are performed manually, which increases a risk of defects occurring at connected portions between the conductors.

### PRIOR ART DOCUMENTS

### Patent Documents

(Patent document 1) Korean Patent Publication No. 10-2017-0120936

### DISCLOSURE OF THE INVENTION

### Technical Problem

The present invention provides an intermediate connection structure capable of connecting power cables with different diameters by a more easy and simple method.

Technical objects to be solved by the present invention are not limited to the aforementioned technical objects and unmentioned technical objects will be clearly understood by those skilled in the art to which the present invention belongs.

### Technical Solution

An embodiment of the present invention provide a pre-molded joint (PMJ) with different diameters for intermediate connection between a pair of power cables with different diameters, the PMJ including: a first cable in which a first conductor, a first insulator and a first semiconductor are sequentially formed; a second cable in which a second conductor, a second insulator, and a second semiconductor, which have diameters greater than those of the first conductor, the first insulator, and the first semiconductor, respectively, are sequentially formed; and a rubber unit of which an inner circumferential surface of one side has a first inner diameter connected over the first insulator and the first semiconductor of the first cable, an inner circumferential surface of the other side has a second inner diameter connected over the second insulator and the second semiconductor of the second cable, the second inner diameter is greater than the first inner diameter, the rubber unit includes a central electrode in a center thereof, and an inner surface of the central electrode has a shape of slanting from one side toward the other side thereof.

In an embodiment, an outer surface of the rubber unit may have a shape of slanting from one side toward the other side thereof.

In an embodiment, the PMJ may further include a conductor sleeve having areas with different diameters to be connected with the first conductor and the second conductor, respectively.

In an embodiment, an outer surface of the central electrode may have a shape of slanting from one side toward the other side thereof.

In an embodiment of the present invention, a pre-molded joint (PMJ) with different diameters for intermediate connection between a pair of power cables with different diameters, the PMJ including: a first cable in which a first conductor, a first insulator and a first semiconductor are sequentially formed; a second cable in which a second conductor, a second insulator, and a second semiconductor, which have diameters greater than those of the first conductor, the first insulator, and the first semiconductor, respectively, are sequentially formed; and a rubber unit of which an inner circumferential surface of one side has a first inner diameter connected over the first insulator, an inner circumferential surface of the other side has a second inner diameter connected over the second insulator, the second inner diameter is greater than the first inner diameter, the rubber unit includes a central electrode in a center thereof, and an inner surface of the central electrode has a shape of slanting from one side toward the other side thereof.

In an embodiment of the present invention, a rubber unit for a pre-molded joint (PMJ) with different diameters for connection between high-pressure cables with different diameters, of which an inner circumferential surface of one side has a first inner diameter connected over a first insulator and a first semiconductor of a first cable, an inner circumferential surface of the other side has a second inner diameter connected over a second insulator and a second semiconductor of a second cable, outer diameters of the second insulator and the second semiconductor are greater than those of the first insulator and the first semiconductor, respectively, the second inner diameter is greater than the first inner diameter, the rubber unit includes a central electrode in a center thereof, a semiconductor is formed at each of both sides thereof, and an inner surface of the central electrode has a shape of slanting from one side toward the other side thereof.

In an embodiment, an outer surface of each of the central electrode and the rubber unit may have a shape of slanting from one side toward the other side thereof.

In an embodiment, the first inner diameter may be less than an inner diameter of the first insulator, and the second inner diameter may be less than an inner diameter of the second insulator.

### Advantageous Effects

According to the present invention, the pre-molded joint (PMJ) allows easy connection between the cables even when the expansion rate of the diameter exceeds the typical range, resulting in the extremely wider usage range than the typical PMJ.

Also, the expansion rate of the diameter may be applied in accordance with the insulation outer diameter of each cable by varying the inner diameter size of the PMJ unit.

Also, the manufacturing costs and the processing costs may be reduced, and even workers who have low connection skills may work by using the PMJ instead of using a pre-fabricated joint (PJ).

However, the effects of the present invention are not limited to the aforementioned benefits and may be variously extended without departing from the spirit and scope of the invention.

### BRIEF DESCRIPTION OF THE DRAWINGS

FIG. 1 is a perspective view illustrating a pre-molded joint (PMJ) with different diameters for connection between ultra-high voltage cables with different diameters according to an embodiment of the present invention.

FIG. 2 is a view illustrating a conductor sleeve of the PMJ with different diameters for connection between ultra-high voltage cables with different diameters according to an embodiment of the present invention.

FIG. 3 is a view illustrating a rubber unit of the PMJ with different diameters for connection between ultra-high voltage cables with different diameters according to an embodiment of the present invention.

FIG. 4 is a graph illustrating an interface pressure distribution of the PMJ with different diameters for connection between ultra-high voltage cables according to an embodiment of the present invention.

### MODE FOR CARRYING OUT THE INVENTION

The present invention will now be described more fully with reference to the accompanying drawings, in which exemplary embodiments of the invention are shown. These embodiments are provided so that this disclosure will be thorough and complete, and will fully convey the concept of the invention to those skilled in the art. The invention may, however, be embodied in many different forms and should not be construed as being limited to the embodiments set forth herein. Therefore, it will be understood that the embodiments disclosed in this specification includes some variations without limitations to the shapes as illustrated in the FIGS. Also, the position or the arrangement of each component in the embodiment may be varied without departing form the spirit or scope of the invention. The preferred embodiments should be considered in descriptive sense only and not for purposes of limitation. Therefore, the scope of the invention is defined not by the detailed description of the invention but by the appended claims, and all differences within the scope will be construed as being included in the present invention. In the drawings, like reference numerals refer to like elements throughout.

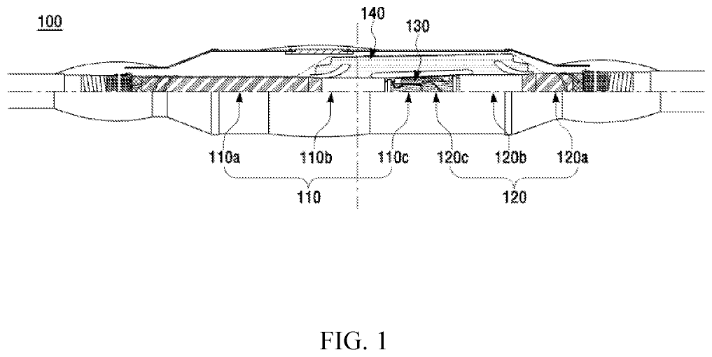

FIG. 1 is a perspective view illustrating a pre-molded joint (PMJ) with different diameters for connection between ultra-high voltage cables with different diameters according to an embodiment of the present invention.

As illustrated in FIG. 1, a PMJ 100 with different diameters for connection between ultra-high voltage cables with different diameters according to an embodiment of the present invention is a connection box for connecting a first cable 110 and a second cable 120 and disposed therebetween.

Here, the first cable 110 and the second cable 120 represent cables with different outer diameters (different specifications).

The first cable 110 is formed in an order of a metal sheath, a first semiconductive layer 110a, a first insulator 110b, and a first conductor 110c in a direction from the outside thereof. Similarly, the second cable 120 is formed in an order of a metal sheath, a second semiconductive layer 120a, a second insulator 120b, and a second conductor 120c in a direction from the outside thereof. Here, outer diameters of the metal sheath, the semiconductive layer, the insulator, and the conductor are different from each other.

FIG. 1 shows an example in which the second cable 120 has an outer diameter greater than that of the first cable 110.

Here, although a difference in outer diameters represents that the outer diameters of the conductor, the insulator, and the semiconductor are different from each other, the difference in outer diameters may also represent that the outer diameters of the insulator and the semiconductor are different from each other while the outer diameter of the conductor is not different.

For the connection between the first cable 110 and the second cable 120, which have different outer diameters, a process of exposing the metal sheath, the first and second semiconductors 110a and 120a, the first and second insulators 110b and 120b, and the first and second conductors 110c and 120c in an order may be performed in advance.

Due to the above-described process, a conductor connection between the first and second conductors 110c and 120c is formed, and the conductor connection performs mechanical and electrical connection between the conductors by using a member called a conductor sleeve 130.

Thereafter, as the first cable 110 and the second cable 120 are inserted so that a layer in which the first and second semiconductors 110a and 120a are exposed is covered by the rubber unit 140, an intermediate connection layer is formed.

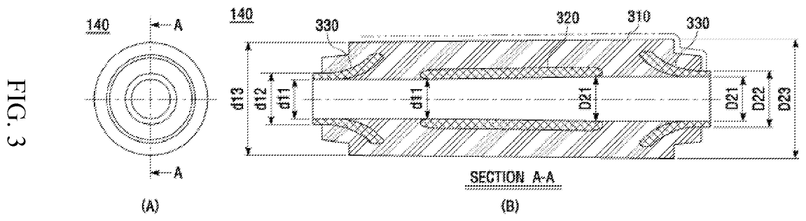

Here, a central electrode 320 (refer to FIG. 3) of the rubber unit 140 is connected so as to be electrically conductive with the conductor sleeve 130, and the semiconductors 330 formed on both sides of the rubber unit 140 are connected to electrically contact the first and second semiconductors 110a and 120a of the first and second cables 110 and 120.

Here, since the outer diameters of the conductor, the insulator, and the semiconductors of the first and second cables 110 and 120 are different from each other, the first and second cables 110 and 120 may not be connected by a typical rubber unit.

Since the typical rubber unit has a structure with the same inner and outer diameters, a cable with a large outer diameter may not be inserted into the typical rubber unit. Also, when a cable with a small outer diameter is inserted into the rubber unit, a gap may be generated therebetween to cause lack of interfacial pressure and absence of electrical withstand characteristics required for high voltage, thereby causing insulation breakdown of an insulation material.

Thus, according to the present invention, a rubber unit used for connecting cables with different outer diameters is designed to have different outer diameter to secure easy connection between cables with different diameters and ensure interfacial pressure characteristics of both sides of a cable after connection to be remained within a designed range.

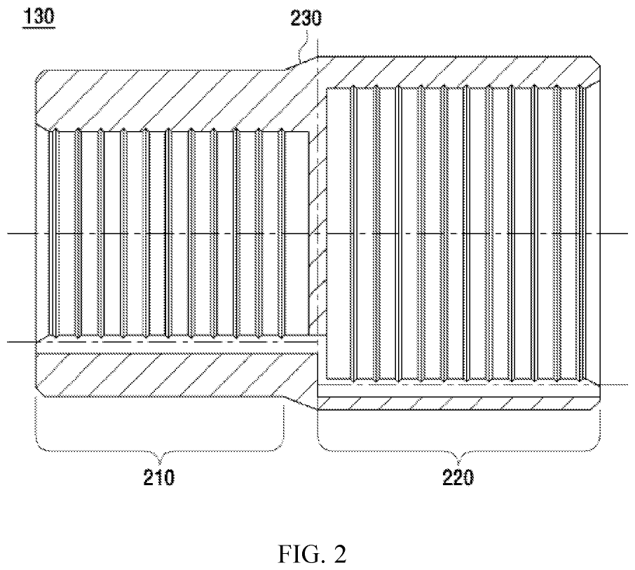

For the connection between cables with different outer diameters, a conductor sleeve for connecting conductors with different diameters and a rubber unit for connecting an insulator and a semiconductor, which have different outer diameters are required to be modified in design, which are illustrated in FIGS. 2 and 3, respectively.

FIG. 2 is a view illustrating the conductor sleeve of the PMJ with different diameters for connection between ultra-high voltage cables with different diameters according to an embodiment of the present invention.

The conductor sleeve 130 may be made of a conductive metal material and formed on a region with different inner and outer diameters as illustrated.

A first conductor 210 is an area to which a first conductor 110c of the first cable 110 is inserted and connected, and a second conductor 220 is an area to which a second conductor 210c of the second cable 210 is inserted and connected.

Each of the first and second conductors 210 and 220 may have an inner diameter that allows the first and second conductors 110c and 120c to be inserted and connected.

The first and second conductors 210 and 220 may be connected to each other through a connector 230.

FIG. 3 is a view illustrating the rubber unit of the PMJ with different diameters for connection between ultra-high voltage cables with different diameters according to an embodiment of the present invention.

Referring to FIG. 3, (A) of FIG. 3 is a cross-sectional view, and (B) of FIG. 3 is a longitudinal sectional view.

The rubber unit 140 has a cylindrical shape in which a cylindrical space into which the first and second cables 110 and 120 are insertable is formed therein, a central electrode 320 that is able to electrically contact the first and second conductors 110c and 120c is formed at a center thereof, and a rubber insulator 310 that is able to sufficiently withstand an operation voltage is formed on an outer circumference of the central electrode 320.

A semiconductor 330 for electric field mitigation may be additionally formed on both inner sides of the rubber insulator 310.

A rubber insulator 310 of the rubber unit 140 is made of an insulating silicone rubber material, the central electrode 320 is made of a conductive silicone rubber material, and the semiconductor 330 is made of a semiconductive silicone rubber material.

An inner side of the semiconductor 330 may be connected to outer sides of the first and second semiconductors 110a and 120a of the first and second cables 110 and 120.

The rubber unit 140 may have a left side that is an area connected with the first cable 110 and a right side that is an area connected with the second cable 120.

The left side of the rubber unit 140 has an inner diameter d11, an outer diameter d12 of a start portion of the semiconductor, and an outer diameter d13 of the rubber unit, and the right side has an inner diameter D21, an outer diameter D22 of a start portion of the semiconductor, and an outer diameter D23 of the rubber unit.

A relationship of d11<D21, d12<D22, and d13<D23 may be established, and the inner diameters d11 and D21 may have sizes corresponding to those of outer diameters of the insulators and semiconductors of the first and second cables 110 and 120.

That is, it is designed that the inner diameters d11 and D21 are less than the outer diameters of the insulator and semiconductors of the first and second cables 110 and 120, and interface pressure between an inner surface of the rubber unit 140 and outer surfaces of the insulator and semiconductors of the first and second cables 110 and 120 is within a designed range.

The rubber unit 140 is elastic because the rubber unit 140 is made of a rubber material. Thus, the rubber unit 140 is designed to be less than an insulation outer diameter of the cable to maintain a predetermined interface pressure.

In general, an expansion rate of the diameter of the rubber unit 140 may be ranged from 120% to 140%.

In the central electrode 320 disposed at the center of the rubber unit 140, an inner diameter at a left start point is equal to the inner diameter d11 of the rubber unit 140, and an inner diameter at a right end point is equal to the inner diameter D21 of the rubber unit 140.

That is, the central electrode 320 forms a slanted surface from the left start point to the right end point at a predetermined angle.

As the inner surface of the central electrode 320 is formed as the slanted surface, the outer surface of the central electrode 320 may be also formed as a slanted surface.

Since the outer surface of the central electrode 320 is formed as a slanted surface, the outer surface of the rubber unit 140 also may have a slanted surface, and the rubber unit 140 may secure a predetermined insulation thickness starting from the outer diameter d13 at the start point to the outer diameter D23 at the end point to secure the insulation thickness based on an electrical design of the insulator.

When the above-described structure is designed, connection between the left and right sides may be formed within a designed interface pressure range as same as existing connection, a connection space between conductors with different outer diameters may be secured by allowing the inner surface of the central electrode 320 to be formed as the slanted surface, and the insulation thickness having sufficient voltage withstanding characteristics may be secured by allowing the outer surface of the rubber unit 140 to be formed as the slanted surface.

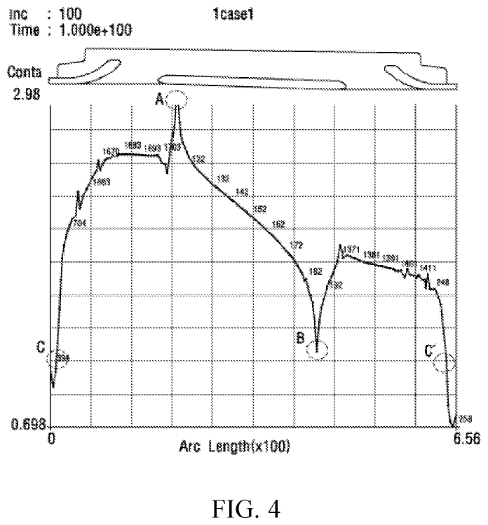

FIG. 4 is a graph illustrating an interface pressure distribution of the PMJ with different diameters for connection between ultra-high voltage cables according to an embodiment of the present invention.

Referring to FIG. 4, results obtained by measuring interface pressure at respective positions of the first and second cables 110 and 120 that are in contact with the inner surface of the PMJ 100 after the first and second cables 110 and 120 with different outer diameters are inserted into the PMJ 100 with different outer diameters according to the present invention may be known.

In an embodiment, a 138 kV XLPE first cable 110 with a conductor outer diameter of 43.7 mm and an insulation outer diameter of 82.7 mm and a 138 kV XLPE second cable 210 with a conductor outer diameter of 62.7 mm and an insulation outer diameter of 101.7 mm are connected to a rubber unit 140 (having a predetermined expansion rate of a diameter) with a left inner diameter d11 of 66 mm and a right inner diameter D21 of 74 mm, and then interfaces at respective positions are measured.

A designed reference value of interface pressure between the rubber unit 140 and the cable is designed to be equal to or greater than 1.0 [kgf/cm₂].

Referring to the graph of FIG. 4, it is measured that a maximum interface pressure between the PMJ 100 and the cable is 3.045 [kgf/cm²] at position A, a minimum interface pressure at a deflector (end positions C and C′ of the semiconductor 330) is 1.03 [kgf/cm²], and a minimum interface pressure of the central electrode 320 is 1.25 [kgf/cm²] at a slope start portion (position B) of the second cable 120.

It may be known from the above measurement results that all interfaces secure sufficient interface pressures within the above-described designed reference range.

Features, structures, and effects described in the above embodiments are incorporated into at least one embodiment of the present disclosure, but are not limited to only one embodiment. Moreover, features, structures, and effects exemplified in one embodiment may easily be combined and modified for another embodiment by those skilled in the art. Therefore, these combinations and modifications should be construed as falling within the scope of the present disclosure. Moreover, features, structures, and effects exemplified in one embodiment may easily be combined and modified for another embodiment by those skilled in the art. Therefore, these combinations and modifications should be construed as falling within the scope of the present invention.

Although embodiments have been described with reference to a number of illustrative embodiments thereof, it should be understood that numerous other modifications and embodiments may be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

[Description of reference numerals]

| | |
|---|---|
| 100: PMJ | 110: First cable |
| 110a: First semiconductor | 110b: First insulator |
| 110c: First conductor | 120: Second cable |
| 120a: Second semiconductor | 120b: Second insulator |
| 120c: Second conductor | 130: Conductor sleeve |
| 140: Rubber unit | 210: First conductor |
| 220: Second conductor | 230: Connector |
| 310: Rubber insulator | 320: Central electrode |
| 330: Semiconductor | |

1. A pre-molded joint (PMJ) with different diameters for intermediate connection between a pair of power cables with different diameters, the PMJ comprising:
a first cable in which a first conductor, a first insulator and a first semiconductor are sequentially formed;
a second cable in which a second conductor, a second insulator, and a second semiconductor, which have diameters greater than those of the first conductor, the first insulator, and the first semiconductor, respectively, are sequentially formed; and
a rubber unit of which an inner circumferential surface of one side has a first inner diameter connected over the first insulator and the first semiconductor of the first cable, an inner circumferential surface of the other side has a second inner diameter connected over the second insulator and the second semiconductor of the second cable, the second inner diameter is greater than the first inner diameter, the rubber unit comprises a central electrode in a center thereof, and an inner surface of the central electrode has a shape of slanting from one side toward the other side thereof.

2. The PMJ of claim 1, wherein an outer surface of the rubber unit has a shape of slanting from one side toward the other side thereof.

3. The PMJ of claim 1, further comprising a conductor sleeve having areas with different diameters to be connected with the first conductor and the second conductor, respectively.

4. The PMJ of claim 1, wherein an outer surface of the central electrode has a shape of slanting from one side toward the other side thereof.

5. A pre-molded joint (PMJ) with different diameters for intermediate connection between a pair of power cables with different diameters, the PMJ comprising:
a first cable in which a first conductor, a first insulator and a first semiconductor are sequentially formed;
a second cable in which a second conductor, a second insulator, and a second semiconductor, which have diameters greater than those of the first conductor, the first insulator, and the first semiconductor, respectively, are sequentially formed; and
a rubber unit of which an inner circumferential surface of one side has a first inner diameter connected over the first insulator, an inner circumferential surface of the other side has a second inner diameter connected over the second insulator, the second inner diameter is greater than the first inner diameter, the rubber unit comprises a central electrode in a center thereof, and an inner surface of the central electrode has a shape of slanting from one side toward the other side thereof.

6. A rubber unit for a pre-molded joint (PMJ) with different diameters for connection between high-pressure cables with different diameters, of which an inner circumferential surface of one side has a first inner diameter connected over a first insulator and a first semiconductor of a first cable,
an inner circumferential surface of the other side has a second inner diameter connected over a second insulator and a second semiconductor of a second cable,
outer diameters of the second insulator and the second semiconductor are greater than those of the first insulator and the first semiconductor, respectively,
the second inner diameter is greater than the first inner diameter,
the rubber unit comprises a central electrode in a center thereof,
a semiconductor is formed at each of both sides thereof, and
an inner surface of the central electrode has a shape of slanting from one side toward the other side thereof.

7. The rubber unit of claim 6, wherein an outer surface of each of the central electrode and the rubber unit has a shape of slanting from one side toward the other side thereof.

8. The rubber unit of claim 6, wherein the first inner diameter is less than an inner diameter of the first insulator, and the second inner diameter is less than an inner diameter of the second insulator.
